(19) United States
(12) Patent Application Publication
(10) Pub. No.: US 2005/0084804 A1
(43) Pub. Date: Apr. 21, 2005

(54) Low surface energy templates

(75) Inventors: Van N. Truskett, Austin, TX (US); Christopher J. MacKay, Austin, TX (US); Sreenivasan V. Sidlgata, Austin, TX (US); Ronald D. Voisin, Austin, TX (US)

Correspondence Address: MOLECULAR IMPRINTS, INC., PO BOX 81536, AUSTIN, TX, 78708-1536, US

(73) Assignee: MOLECULAR IMPRINTS, INC., Austin, TX (US)

(21) Appl. No.: 10/687,519

(22) Filed: Oct. 16, 2003

(51) Int. Cl. G03C 5/00

(52) U.S. Cl. 430/311

(57) ABSTRACT

The present invention pertains to disposing a diamond-like composition on a template, wherein the diamond-like composition acts as a release layer. The diamond-like composition is substantially transparent to actinic radiation, e.g., ultraviolet (UV) light, and will also have a desired surface energy, wherein the desired surface energy minimizes adhesion between the template and an underlying material disposed on a substrate. The diamond-like composition is characterized with a low surface energy that exhibits desirable release characteristics.

### BACKGROUND OF THE INVENTION

The field of the invention relates generally to micro-fabrication of structures. More particularly, the present invention is directed to the production of a template having improved release properties.

Micro-fabrication involves the fabrication of very small structures, e.g., having features on the order of micro-meters or smaller. One area in which micro-fabrication has had a sizeable impact is in the processing of integrated circuits. As the semiconductor processing industry continues to strive for larger production yields while increasing the circuits per unit area formed on a substrate, micro-fabrication becomes increasingly important. Micro-fabrication provides greater process control while allowing increased reduction of the minimum feature dimension of the structures formed.

Optical lithography techniques are currently used in micro-fabrication. However, these methods are potentially reaching their limits in resolution. Sub-micron scale lithography has been a crucial process in the microelectronics industry. The use of sub-micron scale lithography allows manufacturers to meet the increased demand for smaller and more densely packed electronic components on chips.

An exemplary micro-fabrication technique is shown in U.S. Pat. No. 6,334,960 to Willson et al. [hereinafter referred to as Willson]. Willson discloses a method of forming a relief image in a structure. The method includes providing a substrate having a transfer layer. The transfer layer is covered with a polymerizable fluid composition. A mold makes mechanical contact with the polymerizable fluid. The mold includes a relief structure, and the polymerizable fluid composition fills the relief structure. The polymerizable fluid composition is then subjected to conditions to solidify and polymerize the same, forming a solidified polymeric material on the transfer layer that contains a relief structure complimentary to that of the mold. The mold is then separated from the solid polymeric material such that a replica of the relief structure in the mold is formed in the solidified polymeric material. The transfer layer and the solidified polymeric material are subjected to an environment to selectively etch the transfer layer relative to the solidified polymeric material such that a relief image is formed in the transfer layer. To minimize adhesion between the solidified polymeric material and the mold, a release layer is disposed on the mold. The release layer functions to provide a low energy surface to enhance mold release, thereby minimizing distortions in the pattern due, inter alia, to removal of the mold from the solidified polymeric material.

Thus, a need exists to provide a mold with improved release properties.

### SUMMARY OF THE INVENTION

The present invention pertains to disposing a diamond-like composition on a template, wherein the diamond-like composition acts as a release layer. The diamond-like composition is substantially transparent to actinic radiation, e.g., ultraviolet (UV) light, and will also have a desired surface energy, wherein the desired surface energy minimizes adhesion between the template and an underlying material disposed on a substrate. The diamond-like composition is characterized with a low surface energy that exhibits desirable release characteristics. Specifically, the low surface energy of the diamond-like composition minimizes the adhesion of the material onto a mold included on the template. As a result, the material is more likely to adhere to the substrate than to adhere to the template. By reducing the adhesion of the material to the substrate, the quality of the features defined in the material is improved. The diamond-like composition may also be doped with a metallic species to allow discharge of electrons. Alternatively, an electrically conductive layer may be disposed adjacent to the diamond-like composition to provide electron discharge. The electrically conductive layer may be positioned so that the diamond-like composition is disposed between the electrically conductive layer and the substrate. Also, the electrically conductive layer may be positioned between the diamond-like composition and the substrate. These and other embodiments are described in further detail below.

### BRIEF DESCRIPTION OF THE DRAWINGS

FIG. 1 is a perspective view of a lithographic system in accordance with the present invention;

FIG. 2 is a simplified elevation view of a lithographic system shown in FIG. 1;

FIG. 3 is a simplified representation of the material from which an imprinting layer, shown in FIG. 2, is comprised before being polymerized and cross-linked;

FIG. 4 is a simplified representation of a cross-linked polymer material into which the material shown in FIG. 3 is transformed after being subjected to radiation;

FIG. 5 is a simplified elevation view of a template spaced-apart from the imprinting layer, shown in FIG. 1, after patterning of the imprinting layer;

FIGS. 6-9 are cross-sectional views of the template shown in FIG. 1 during different stages of fabrication;

FIGS. 10-12 are cross-sectional views of the template shown in FIG. 1 during different stages of fabrication in accordance with an alternate embodiment; and

FIG. 13 is a simplified elevation view of a template in accordance of the present invention spaced-apart from a substrate.

### DETAILED DESCRIPTION OF THE INVENTION

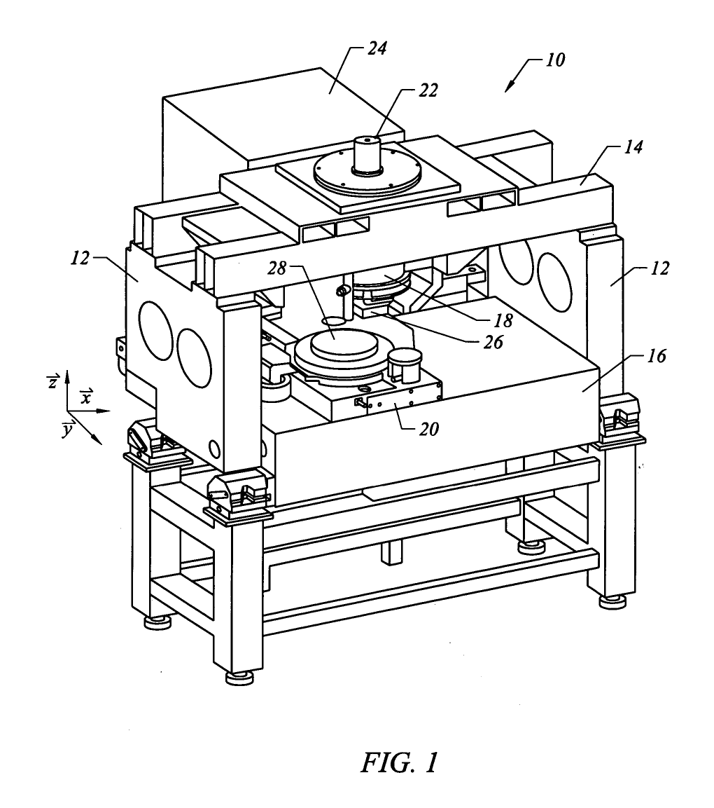

FIG. 1 depicts a lithographic system 10 in accordance with one embodiment of the present invention that includes a pair of spaced-apart bridge supports 12 having a bridge 14 and a stage support 16 extending therebetween. Bridge 14 and stage support 16 are spaced-apart. Coupled to bridge 14 is an imprint head 18, which extends from bridge 14 toward stage support 16. Disposed upon stage support 16 to face imprint head 18 is a motion stage 20. Motion stage 20 is configured to move with respect to stage support 16 along the X- and Y-axes. A radiation source 22 is coupled to lithographic system 10 to impinge actinic radiation upon motion stage 20. As shown, radiation source 22 is coupled to bridge 14 and includes a power generator 24 connected to radiation source 22.

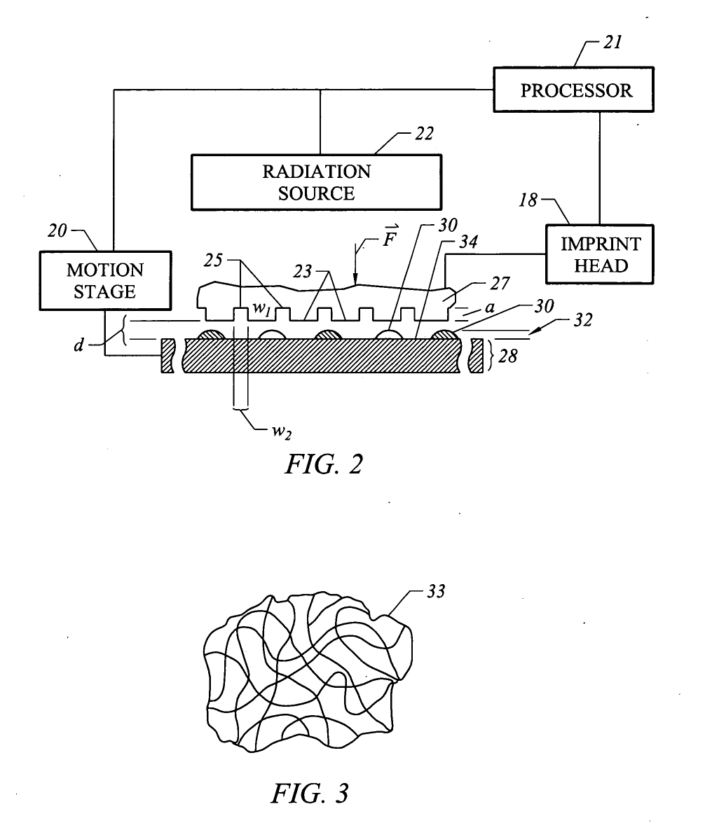

Referring to both FIGS. 1 and 2, connected to imprint head 18 is a template 26 having a mold 27 thereon. Mold 27 includes a plurality of features defined by a plurality of spaced-apart protrusions 23 and recesses 25 having a step height a, on the order of nanometers, e.g., 30 nanometers. The plurality of features defines an original pattern, an inverse of which is to be transferred into a substrate 28 positioned on motion stage 20. To that end, imprint head 18 is adapted to move along the Z-axis and vary a distance “d” between mold 27 and substrate 28. In this manner, the features on mold 27 may be imprinted into a conformable region of substrate 28, discussed more fully below. Radiation source 22 is located such that mold 27 is positioned between radiation source 22 and substrate 28. A processor 21 is in data communication with imprint head 18, motion stage 20, and radiation source 22.

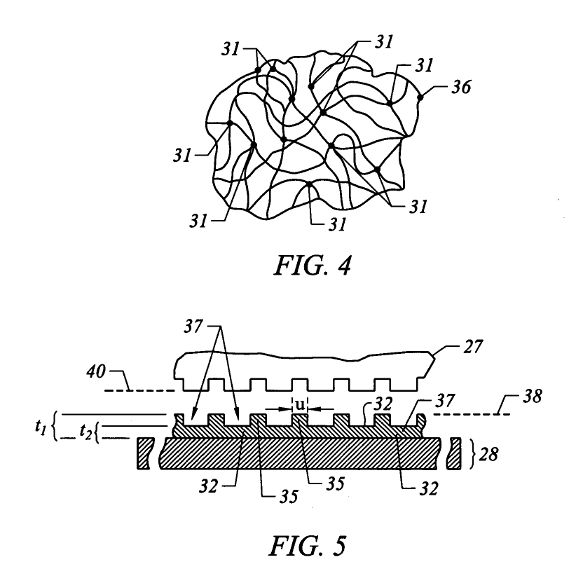

Referring to both FIGS. 2 and 3, a conformable region, such as an imprinting layer 32, is disposed on a portion of a surface 34 that presents a substantially planar profile. It should be understood that the conformable region may be formed using any known technique to produce conformable material, such as a hot embossing process disclosed in U.S. Pat. No. 5,772,905 to Chou, which is incorporated by reference in its entirety herein, or a laser assisted direct imprinting (LADI) process of the type described by Chou et al. in “Ultrafast and Direct Imprint of Nanostructures in Silicon”, Nature, Col. 447, pp. 835-837, June 4602, which is incorporated by reference in its entirety herein. In the present embodiment, however, the conformable region consists of imprinting layer 32 being deposited as a plurality of spaced-apart discrete droplets 30 of an imprinting material 33 on substrate 28, discussed more fully below. Imprinting layer 32 is formed from imprinting material 33 that may be selectively polymerized and cross-linked to record the original pattern therein, defining a recorded pattern. Imprinting material 33 is shown in FIG. 4 as being cross-linked at points 31, forming a cross-linked polymer material 36.

Referring to FIGS. 2, 3 and 5, the pattern recorded in imprinting layer 32 is produced, in part, by mechanical contact with mold 27. To that end, imprint head 18 reduces the distance “d” to allow imprinting layer 32 to come into mechanical contact with mold 27, spreading droplets 30 so as to form imprinting layer 32 with a contiguous formation of imprinting material 33 over surface 34. In one embodiment, distance “d” is reduced to allow sub-portions 35 of imprinting layer 32 to ingress into and fill recesses 25.

To facilitate filling of recesses 25, imprinting material 33 is provided with the requisite properties to completely fill recesses 25 while covering surface 34 with a contiguous formation of imprinting material 33. In the present embodiment, sub-portions 37 of imprinting layer 32 in superimposition with protrusions 23 remain after the desired, usually minimum distance “d”, has been reached, leaving sub-portions 35 with a thickness t₁, and sub-portions 37 with a thickness t₂. Thicknesses “t₁.” and “t₂” may be any thickness desired, dependent upon the application. Typically, t₁ is selected so as to be no greater than twice the width u of sub-portions 35, i.e., t₁<2u, shown more clearly in FIG. 5.

Referring to FIGS. 2, 3 and 4, after a desired distance “d” has been reached, radiation source 22 produces actinic radiation that polymerizes and cross-links imprinting material 33, forming cross-linked polymer material 36. As a result, the composition of imprinting layer 32 transforms from imprinting material 33 to cross-linked polymer material 36. Specifically, cross-linked polymer material 36 is solidified to provide a side 38 of imprinting layer 32 with a shape conforming to a shape of a surface 40 of mold 27. After imprinting layer 32 is transformed to consist of cross-linked polymer material 36, shown in FIG. 4, imprint head 18, shown in FIG. 2, is moved to increase distance “d” so that mold 27 and imprinting layer 32 are spaced-apart.

Referring to FIG. 5, additional processing may be employed to complete the patterning of substrate 28. For example, substrate 28 and imprinting layer 32 may be etched to transfer the pattern of imprinting layer 32 into substrate 28, providing a patterned surface (not shown). To facilitate etching, the material from which imprinting layer 32 is formed may be varied to define a relative etch rate with respect to substrate 28, as desired.

To that end, imprinting layer 32 may be provided with an etch differential with respect to photo-resist material (not shown) selectively disposed thereon. The photo-resist material (not shown) may be provided to further pattern imprinting layer 32, using known techniques. Any etch process may be employed, dependent upon the etch rate desired and the underlying constituents that form substrate 28 and imprinting layer 32.

Referring to both FIGS. 1 and 2, an exemplary radiation source 22 may produce ultraviolet radiation; however, any known radiation source may be employed. The selection of radiation employed to initiate the polymerization of the material in imprinting layer 32 is known to one skilled in the art and typically depends on the specific application which is desired.

Referring to FIGS. 1, 2 and 5, the pattern produced by the present patterning technique may be transferred into substrate 28 to provide features having aspect ratios as great as 30:1. To that end, one embodiment of mold 27 has recesses 25 defining an aspect ratio in a range of 1:1 to 10:1. Specifically, protrusions 23 have a width W₁ in a range of about 10 nm to about 5000 μm, and recesses 25 have a width W₂ in a range of 10 nm to about 5000 μm. As a result, template 26 and/or mold 27 may be formed from various conventional materials, including, but not limited to, fused-silica, quartz, silicon, organic polymers, siloxane polymers, borosilicate glass, fluorocarbon polymers, metal, hardened sapphire and the like.

Referring to FIGS. 5 and 6, a desired characteristic of mold 27 is that the adherence of cross-linked polymer material 36 thereto is minimized. To that end, a surface of mold 27 may be treated with a modifying agent, referred to as a release layer 42. To function satisfactorily, it is desired that release layer 42 should adhere well to mold 27 without adhering well to imprint cross-linked polymer material 36, should be relatively transparent to actinic radiation, as well as mechanically sound to minimize premature operational failure. Suitable materials for use as release layer 42 are referred to as diamond-like compositions, such as diamond-like carbon (DLC) or diamond-like nano-composite available under the tradename DYLYN® from The Bekaert Group, Amherst, N.Y. Diamond-like compositions are characterized as a low surface energy material that exhibit release characteristics to cross-linked polymer material 36. Specifically, surface energies associated with DLC is in a range of 25 to 40 mN/m (milli-Newtons per meter). The surface energies associated with DYLYN® is in a range of 31.51±1.2 mN/m. The low surface energies associated with diamond-like compositions minimize the adhesion of cross-linked polymer material 36 to mold 27. As a result, cross-linked polymer material 36 of imprinting layer 32 is less likely to tear or shear during separation of mold 27 from cross-linked polymer material 36 in imprinting layer 32.

Release layer 42 is also substantially transparent to actinic radiation, e.g., UV light. Transparency of release layer 42, as well as mold 27, to actinic radiation is desired in imprint lithography. Without actinic radiation propagating through both release layer 42 and mold 27, imprinting material 33 would not solidify into cross-linked polymer material 36, shown in FIG. 4. To that end, release layer 42 should not have a thickness, h₁, that would prevent sufficient actinic radiation from propagating therethrough to polymerize material 33. In the present embodiment, release layer is no greater than 500 nm thick. Moreover, release layer 42 should be sufficiently thick to facilitate formation of recesses having desired depth, h₂, to form the desired pattern and without exposing the material from which mold 27 is formed.

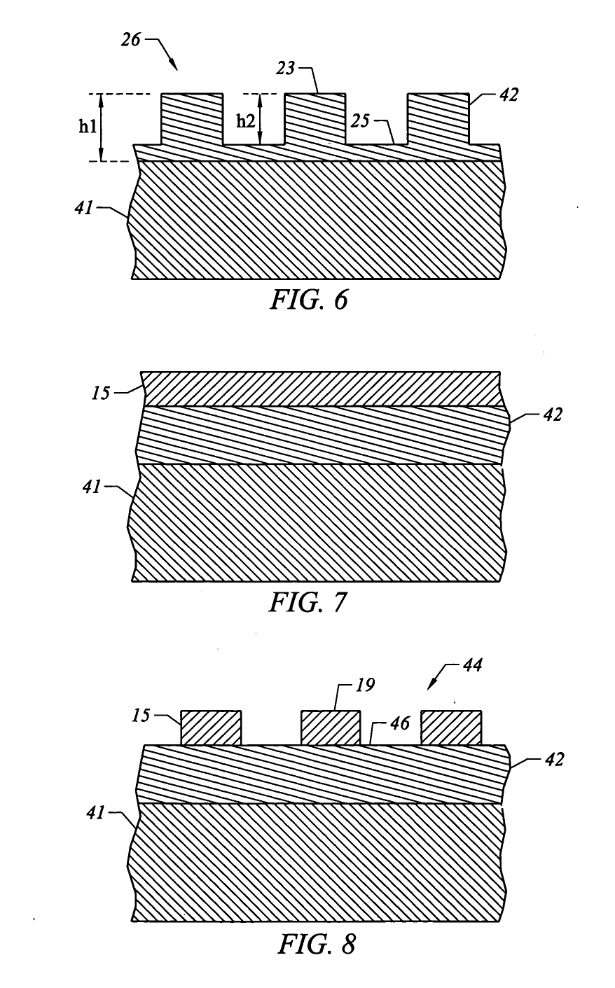

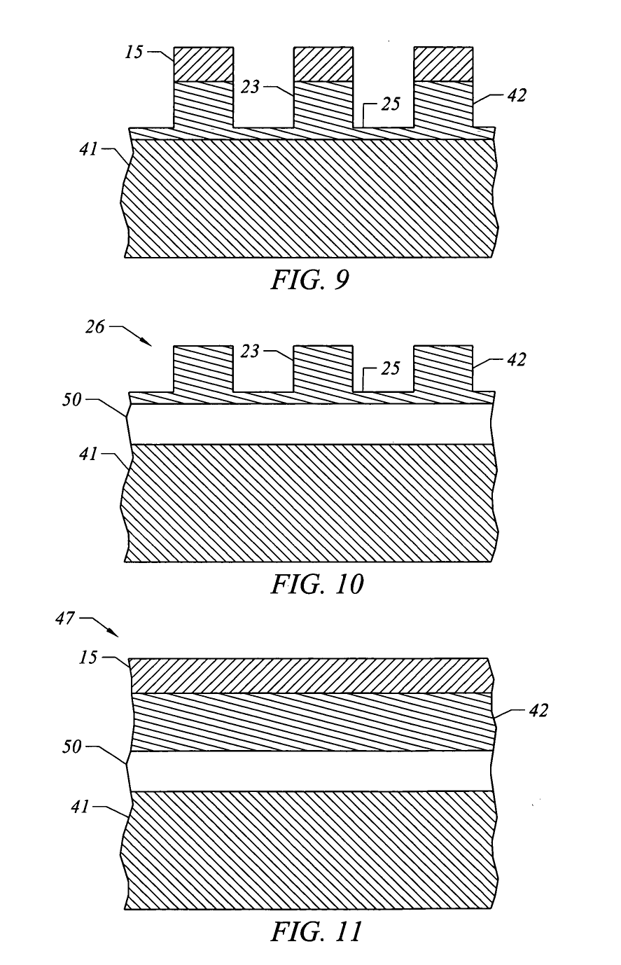

Referring to FIGS. 5 and 7, in an exemplary embodiment, release layer 42 is formed upon mold 27 during fabrication of template 26. To that end, a body 41 is provided that is composed of any of a variety of materials mentioned above, e.g., fused silica. Specifically, release layer 42 is formed on body 41 employing any known deposition technique, such as chemical vapor deposition (CVD), plasma vapor deposition (PVD), atomic layer deposition (ALD) and the like.

After formation of release layer 42, positive or negative photoresist processes may be employed to pattern the same. To that end, a photoresist layer 15 is deposited adjacent to release layer 42. The photoresist forms a patterned structure 44 in which regions 46 of release layer 42 are exposed, shown in FIG. 8. Patterned structure 44 is then subjected to suitable etch processes, such as chemical etching and/or plasma etching to form a relief structure in release layer 42. A conventional oxygen RIE dry etch process is used to etch diamond like films. An exemplary process is disclosed by Taniguchi et al. in DIAMOND NANOIMPRINT LIGHOGRAPHY, Nanotechnology 13 (2002) 592-596. Typical conditions of a plasma processing environment 9not shown) include providing 100 Watts of power, 50 sccm oxygen at a pressure 6 Pascals. The relief structure formed into release layer 42 defines the original pattern mentioned above and includes protrusions 23 and recesses 25. The geometry of the relief structure formed in release layer 42 may be any known in the art, including arcuate projections and recesses; and/or linear projections and recesses; and/or circumferential projections and recesses and the like. Thereafter, the remaining portions of photoresist layer 15 are removed by exposing the same to a process that does not damage, or otherwise compromise, the structural integrity of release layer 42. For example, a chemical bath, such as sulfuric acid (H₂SO₄) or an oxygen (O₂) plasma, may be employed. From the foregoing process, a thickness h₁, shown in FIG. 6, is defined from the interface of release layer 42 with body 41 to an apex of protrusions 23. Protrusions 23 have a thickness h₂, measured from a nadir of recesses 25 to the apex of protrusions 23.

In a further embodiment, release layer 42 may be doped with conductive material to facilitate electric discharge during e-beam lithography and scanning electron microscope inspection. Doping may include metals or other elements. Alternatively, electrically conductive material (not shown) may be applied adjacent to release layer 42 so that release layer 42 is disposed between the electrically conductive material and body 41.

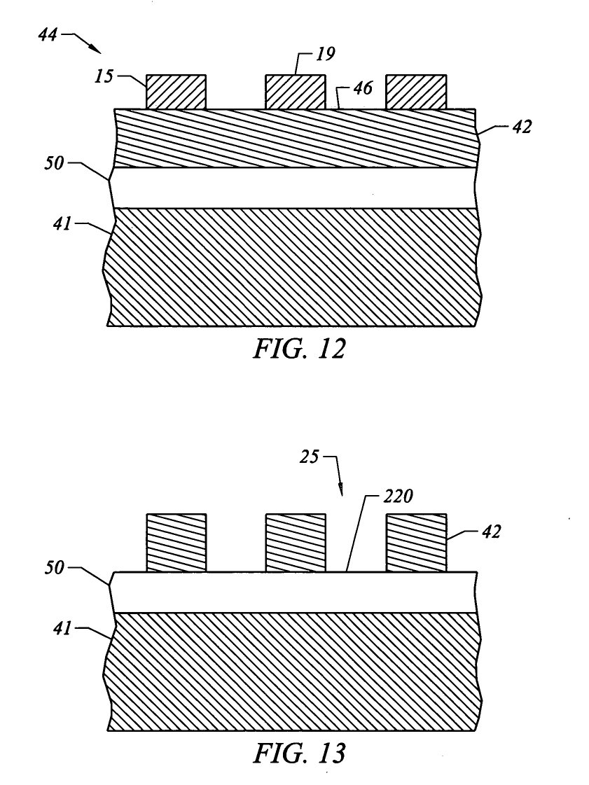

Referring to FIG. 10, alternatively, a layer of conducting material may be disposed between substrate 28 and release layer 42, shown as electrically conductive layer 50. To that end, as shown in FIG. 11, electrically conductive layer 50 may be deposited on substrate 28 employing any suitable deposition technique, such as chemical vapor deposition (CVD) and plasma vapor deposition (PVD), atomic layer deposition (ALD) and the like. It is desired that the conducting layer be formed from a material that is substantially transparent to the actinic radiation for the reasons discussed above. An exemplary material from which conducting layer can be formed is Indium Tin Oxide (ITO).

After formation of electrically conductive layer 50, release layer 42 is deposited adjacent thereto in the manner discussed above. Thereafter, positive or negative photoresist processes may be employed to pattern the same. To that end, photoresist layer 15 is deposited adjacent to release layer 42 forming stacked structure 47, forming patterned structure 44 in which regions 46 of release layer 42 are exposed, shown in FIG. 12. Thereafter, patterned structure 44 is subjected to etch processes, such as chemical etching and/or plasma etching appropriate for the particular material to form a relief structure in release layer 42. The relief structure formed into release layer 42 defines an inverse of the original pattern mentioned above and includes protrusions 23 and recesses 25, shown in FIG. 10. Subsequently, the remaining portions of photoresist layer (not shown) are removed by exposing the same to a process that does not damage, or otherwise compromise, the structural integrity of release layer 42.

Referring again to FIG. 11, in an alternate embodiment, stacked structure 47 may be etched to expose regions 220 of electrically conductive layer 50, shown in FIG. 13. This has been found to be beneficial due to the wetting properties of ITO in electrically conductive layer 50. Specifically, forming electrically conductive layer 50 from oxygen-plasma treated ITO provides the same with a surface energy of approximately 65 mN/m. This provides suitable wetting of imprinting material 33, thereby ensuring that the same is driven into recesses 25.

While this invention has been described with references to various illustrative embodiments, the description is not intended to be construed in a limiting sense. Various modifications and combinations of the illustrative embodiments, as well as other embodiments of the invention, will be apparent to persons skilled in the art upon reference to the description. It is, therefore, intended that the appended claims encompass any such modifications or embodiments.

1. A method of creating a template, said method comprising:
disposing a diamond-like composition on a surface of said template having properties sufficient to be substantially transmissive of a predetermined wavelength and provide said surface.

2. The method as recited in claim 1 wherein disposing further includes disposing said diamond-like composition from a set of diamond-like compositions consisting of including diamond-like carbon (DLC) and diamond-like nano-composites.

3. The method as recited in claim 2 wherein said nano-composites includes DYLYN®.

4. The method as recited in claim 1 wherein said predetermined wavelength includes UV light.

5. The method as recited in claim 1 where disposing further includes patterning said diamond-like composition.

6. The method as recited in claim 1 further including doping said diamond-like composition with electrically conductive elements.

7. The method as recited in claim 1 further including depositing an electrically conductive layer upon said substrate before depositing said diamond-like composition.

8. The method as recited in claim 1 further including depositing an electrically conductive layer upon said substrate before depositing said diamond-like composition and patterning said diamond-like composition to selectively expose regions of said electrically conductive layer.

9. The method as recited in claim 1 further including forming said template from a fused-silica.

10. A method of creating a template, said method comprising:
disposing a diamond-like composition on a surface of said template having properties sufficient to be substantially transmissive of a predetermined wavelength and provide said surface with a predetermined surface energy; and
patterning said diamond-like composition to includes a plurality of protrusions and recesses.

11. The method as recited in claim 10 wherein disposing further includes disposing said diamond-like composition from a set of diamond-like compositions consisting of including diamond-like carbon (DLC) and DYLYN®.

12. The method as recited in claim 10 wherein said predetermined wavelength includes UV light.

13. The method as recited in claim 10 further including doping said diamond-like composition with electrically conductive elements.

14. The method as recited in claim 10 further including depositing an electrically conductive layer upon said substrate before depositing said diamond-like composition.

15. The method as recited in claim 10 wherein patterning further includes said diamond-like composition to selectively expose regions of said electrically conductive layer.

16. A method of creating a template, said method comprising:
forming an electrically conductive layer on said template having properties to be substantially transmissive of a predetermined wavelength;
disposing a diamond-like composition on a surface of said template having properties sufficient to be substantially transmissive of said predetermined wavelength and provide said surface with a predetermined surface energy; and
patterning said diamond-like composition to includes a plurality of protrusions and recesses and selective expose portions of said electrically conductive layer.

17. The method as recited in claim 16 wherein disposing further includes disposing said diamond-like composition from a set of diamond-like compositions consisting of including diamond-like carbon (DLC) and DYLYN®.

18. The method as recited in claim 16 wherein said predetermined wavelength includes UV light.

19. The method as recited in claim 16 further including depositing an electrically conductive layer upon said substrate before depositing said diamond-like composition.

20. A template for use in imprint lithography, said template comprising:
a body;
a diamond-like composition disposed on said body, with said diamond-like composition being substantially transparent to a predetermined wavelength of light and having a predetermined surface energy associated therewith.

21. The template as recited in claim 20 wherein said diamond-like composition is electrically conductive.

22. The template as recited in claim 20 wherein said diamond-like composition includes a plurality of protrusions and recesses.

23. The template as recited in claim 20 further including an electrically conductive layer position between said body and said diamond-like composition.

24. The template as recited in claim 22 wherein said diamond-like composition includes a plurality of protrusions and recesses, with said electrically conductive layer being exposed in said recesses.

25. The template as recited in claim 22 wherein said electrically conductive layer formed from Indium Tin Oxide.
